(19) United States
(12) Patent Application Publication
(10) Pub. No.: US 2023/0146428 A1
(43) Pub. Date: May 11, 2023

(54) ATLAS CONSTRUCTION OF BRANCHED STRUCTURE FOR IDENTIFICATION OF SHAPE DIFFERENCES AMONG DIFFERENT COHORTS

(71) Applicants: Case Western Reserve University, Cleveland, OH (US); The Cleveland Clinic Foundation, Cleveland, OH (US)

(72) Inventors: Anant Madabhushi, Shaker Heights, OH (US); Golnoush Asaeikheybari, Cleveland Heights, OH (US); Amogh Hiremath, Cleveland, OH (US); Mina K. Chung, Shaker Heights, OH (US); John Barnard, Cleveland, OH (US)

(21) Appl. No.: 17/984,624

(22) Filed: Nov. 10, 2022

Related U.S. Application Data
(60) Provisional application No. 63/277,728, filed on Nov. 10, 2021.

(51) Int. Cl. G06T 7/33; G06V 10/44; G06V 10/764; G06T 7/00

(52) U.S. Cl. CPC G06T 7/33; G06T 7/0016; G06V 10/44; G06V 10/764; G06T 2207/10081; G06T 2207/20224; G06T 2207/30041; G06T 2207/30048; G06T 2207/30061; G06T 2207/30096; G06T 2207/30101

(57) ABSTRACT

Systems, methods, and apparatus are provided for generating an atlas image of a branched structure and predicting a likelihood of success of certain treatments based on the atlas image. In one example, a method includes registering a plurality of images of instances of a branched structure to generate an aligned image for a cohort, wherein the branched structure comprises a central structure and at least one primary branch connected to the central structure; for each primary branch of the branched structure, iteratively registering respective portions of a plurality of images containing the primary branch to generate an aligned image portion of the primary branch; and applying a control grid of the aligned image portion of the primary branch to respective image portions containing the central structure and the other primary branches prior to iteratively registering a next primary branch; and generating an atlas image for the cohort based on the aligned image portions.

### CROSS REFERENCE TO RELATED APPLICATIONS

This application claims the benefit of priority from U.S. Provisional Pat. Application No. 63/277,728 filed Nov. 10, 2021 and entitled “METHOD OF UTILIZING COMPUTATIONALLY IDENTIFIED SHAPE DIFFERENCE PRE-ABLATION SCANS TO DIAGNOSE RECURRENCE OF ATRIAL FIBRILLATION”, the contents of which are incorporated herein by reference in their entirety.

### FEDERAL FUNDING INFORMATION

This invention was made with government support under HL158071 awarded by the National Institutes of Health. The government has certain rights in the invention.

### BACKGROUND

Analyzing medical images of branched structures, such as the heart, presents challenges during atlas construction due to the complex shapes involved. Further, deep learning approaches that include blind feature extraction are not well suited for complex, branched physiological structures.

### BRIEF DESCRIPTION OF THE DRAWINGS

The accompanying drawings, which are incorporated in and constitute a part of the specification, illustrate various example operations, apparatus, methods, and other example embodiments of various aspects discussed herein. It will be appreciated that the illustrated element boundaries (e.g., boxes, groups of boxes, or other shapes) in the figures represent one example of the boundaries. One of ordinary skill in the art will appreciate that, in some examples, one element can be designed as multiple elements or that multiple elements can be designed as one element. In some examples, an element shown as an internal component of another element may be implemented as an external component and vice versa. Furthermore, elements may not be drawn to scale.

FIGS. 1A and 1B illustrate example generalized branched structures.

FIG. 2 is a flow diagram outlining a method for generating an atlas of a branched structure, according to various aspects described.

FIG. 3 is a flow diagram outlining a method for generating an atlas of a branched structure, according to various aspects described.

FIG. 4 is an image illustrating an example segmentation of a left atrial region of a heart.

FIG. 5 illustrates example atlas images for patients who experienced atrial fibrillation after an ablation treatment (AF+ cohort) and for patients who did not experience atrial fibrillation after an ablation treatment (AF- cohort).

FIG. 6 illustrates an atlas image for the AF- cohort indicating example surface of interest (SOI) regions identified by comparing the atlas image for the AF+ cohort with the atlas image for the AF- cohort.

FIG. 7 is a flow diagram outlining a method for predicting a probability of success of an ablation treatment, in accordance with various aspects described.

### DETAILED DESCRIPTION

The description herein is made with reference to the drawings, wherein like reference numerals are generally utilized to refer to like elements throughout, and wherein the various structures are not necessarily drawn to scale. In the following description, for purposes of explanation, numerous specific details are set forth in order to facilitate understanding. It may be evident, however, to one of ordinary skill in the art, that one or more aspects described herein may be practiced with a lesser degree of these specific details. In other instances, known structures and devices are shown in block diagram form to facilitate understanding.

An atlas is a mean shape a plurality of images that captures the characteristics of a whole cohort. Atlas images for different cohorts exhibiting different medical conditions are useful tools in determining differences in patient physiology that may contribute to the respective medical conditions. Analyzing medical images of branched structures, such as the heart, presents challenges during atlas construction due to the complex shapes involved. Further, deep learning approaches that include blind feature extraction are not well suited for complex, branched physiological structures. Disclosed herein are techniques and apparatus for constructing an atlas of a branched physiological structure, such as, for example, a heart, airway tree, tumor, or eye vascular network using a hierarchical approach.

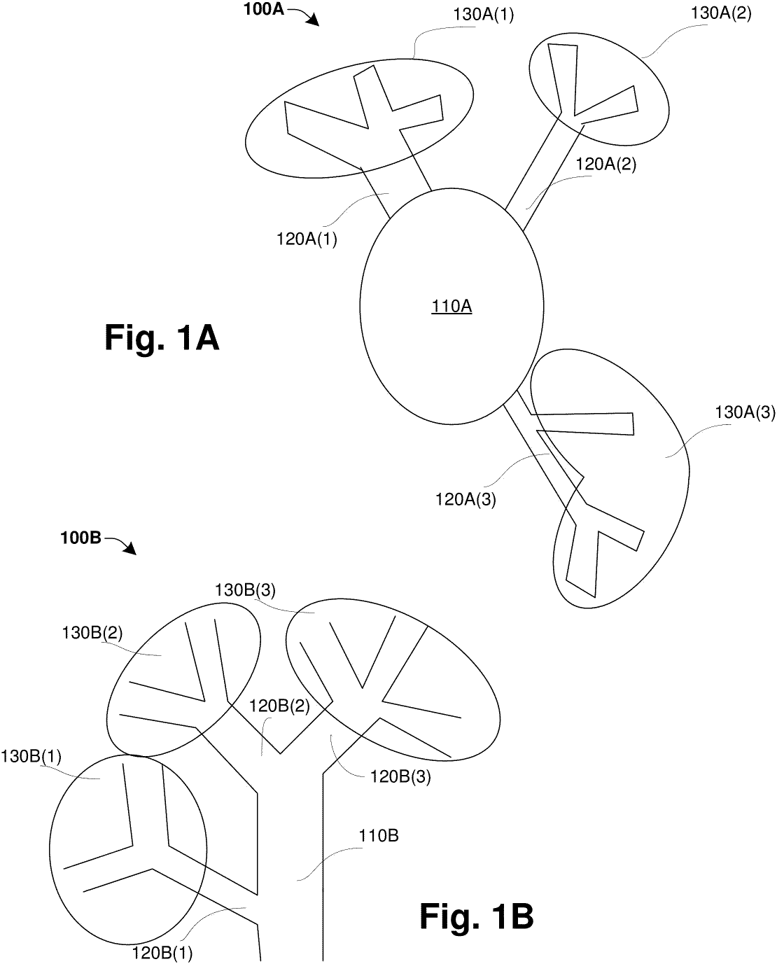

FIG. 1A illustrates a general branched structure 100A that includes a central structure 110A and three primary branches 120A(1), 120A(2), 120A(2) connected to the central structure 110A. A respective set of secondary branches 130A(1), 130A(2), 130A(3) are connected to respective primary branches. The specific numbers of primary branches and secondary branches illustrated in FIG. 1A is arbitrary and different numbers of these elements may be present. In some examples, one or more of the primary branches may not have any associated secondary branches.

One example of the branched structure 100A is a left atrium region of a heart. In this example, the left atrium is the central structure. The right superior pulmonary vein (RSPV), the left superior pulmonary vein (LSPV), the right inferior pulmonary vein (RIPV), and the left inferior pulmonary vein (LIPV) are the primary branches. Respective secondary pulmonary veins connected to a respective one of the RSPV, LSPV, RIPV, LIPV are the secondary branches.

FIG. 1B illustrates another general branched structure 100B that includes a central structure 110B (which is a central branch) and three primary branches 120B(1), 120B(2), 120B(2) connected to the central structure 110B. A respective set of secondary branches 130B(1), 130B(2), 130B(3) are connected to respective primary branches. The specific numbers of primary branches and secondary branches illustrated in FIG. 1B is arbitrary and different numbers of these elements may be present. In some examples, one or more of the primary branches may not have any associated secondary branches. One example of the branched structure 100B is an airway tree in which the central structure 110B is a central airway branch (e.g., a trachea) and the primary branches 120B are primary airway branches that branch from the central airway branch 110B (e.g., bronchii). Secondary branches130B are remaining branches.

Different portions of the vascular network in an eye or associated with a tumor may also be analyzed as branched structures using the disclosed methods.

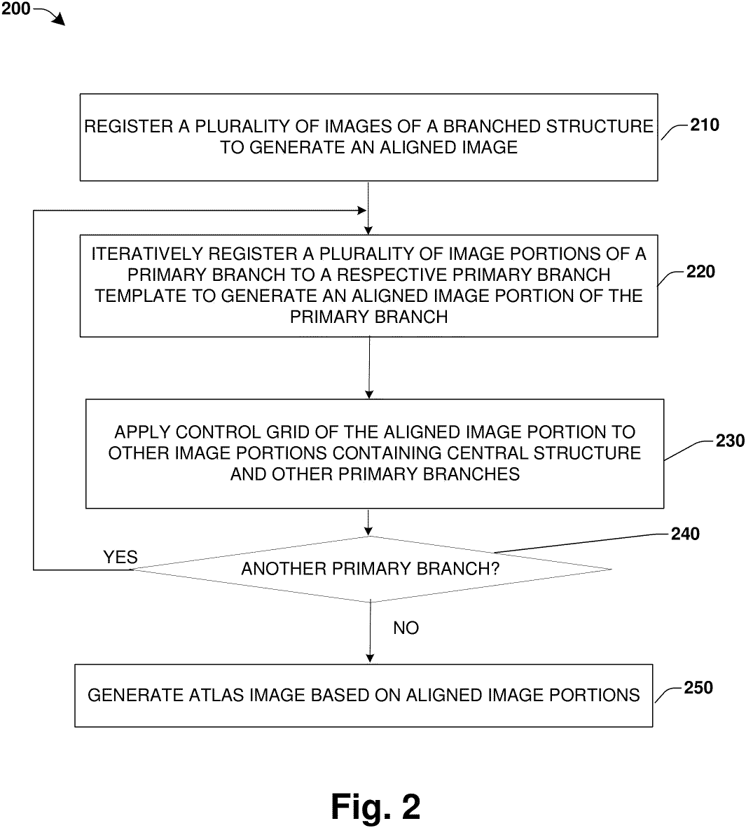

FIG. 2 is a flow diagram outlining a method 200 for generating an atlas image of a branched structure. The method includes, at 210, registering a plurality of images of instances of a branched structure to generate an aligned image for a cohort. For each primary branch of the branched structure, the method includes, at 220, registering a plurality of images of instances of a branched structure to generate an aligned image for a cohort and, at 230, applying a control grid of the aligned image portion of the primary branch to respective image portions containing the central structure and the other primary branches. At 240, a determination is made as to whether all primary branches were processed by operations 220 and 230, and if not, the method returns to 220 and images of a next primary branch are processed. In one example (not shown), operations 220–240 are repeated through several iterations, each including the registration of all the primary branches, for better alignment gradually to keep the fidelity of the branched structure.

Once all primary branches were processed, at 250 an atlas image is generated based on the aligned image portions. The method 200 may be performed separately on images in two or more cohorts so that the resulting atlas images may be compared. In one example the method 200 includes, for each secondary branch connected to a primary branch of the branched structure, applying registration parameters associated with the primary branch to generate an aligned image portion of the secondary branch.

In one example the method 200 includes subtracting or removing secondary branches from each of the plurality of images prior to generating aligned images of the primary branches.

In one example the method 200 includes iteratively registering a primary branch by choosing an arbitrary image portion of the plurality of images as a template; performing an affine registration of an image portion of each remaining image of the plurality images to the template to generate a mean template; and iteratively registering each of the plurality of images or image portions to the mean template to generate the aligned image portion of the primary branch.

In one example the method 200 includes iteratively registering the respective portions of the plurality of images containing the primary branch using a non-rigid intensity based registration based on a cost function featuring at least one regularization method. In one example the at least one regularization method includes a log of a determinant of a Jacobean and at least one L2 regularization term.

In one example the method 200 includes registering an atlas image of a first cohort to an atlas image of a second cohort to align all images in both cohorts to a same spatial basis and analyzing the aligned images to identify regions of interest within one or more primary branches having a statistically different shape as between the first cohort and the second cohort. In this example the method 200 may include extracting shape and texture-based fractal features in the regions of interest and extracting meshbased features in the regions of interest. In this example the method 200 may include classifying a subsequent image as belonging to the first cohort or the second cohort based on a comparison of extracted features of the subsequent image with the extracted features from the images of the first cohort and the images of the second cohort.

In one example, the central structure comprises a left atrium and the primary branches comprise a right superior pulmonary vein (RSPV), a right inferior pulmonary vein (RIPV), a left superior pulmonary vein (LSPV), and a right inferior pulmonary vein (LIPV). In this example a first cohort comprises patients who experienced a post-ablation recurrence of atrial fibrillation and a second cohort comprises patients who did not experience a post-ablation recurrence of atrial fibrillation. In this example, the plurality of images comprise CT scans of the left atrium and pulmonary veins connected to the left atrium taken prior to an ablation treatment.

### Atlas Construction for Left Atrium Region of Heart for Predicting Atrial Fibrillation Recurrence After Catheter Based Ablation

The techniques described above for atlas construction of a branched structure may be employed for predicting atrial fibrillation recurrence after catheter based ablation. Atrial fibrillation (AF) recurrence is the most common arrhythmia which leads to stroke and peripheral embolism and will increase the risk of mortality. Atrial fibrillation is managed by catheter ablation, electrical cardioversion and the administration of anti arrhythmic drugs while catheter ablation is the most common treatment. Despite all the efforts and advancements in AF treatments, AF recurrence happens in 40 to 50% of patients and often multiple operations are needed to control the arrhythmia. Hence, many efforts were made to predict and prevent atrial fibrillation recurrence. The underlying mechanism which causes recurrence is still not very well known.

Previous research suggested that the pulmonary vein and left atrium remodeling are associated with the risk of recurrence. Atlas construction enables analysis of the population differences in a common space. Use of atlas-based shape differentiation method can reveal regions that are structurally associated with recurrence and might potentially represent targets for ablation. Atlas is the mean shape of the aligned regions which captures the characteristics of the whole cohort. Choosing an appropriate registration method for aligning the focused anatomical region and also manifest a spatial resolution among the mean and the subjects is one of the challenges in the atlas construction.

The ability to predict AF recurrence from noninvasive analysis of the cardiac anatomy on CT images will prevent patients from undergoing the suffering ablation procedure if it is not going to work for them in high probability and will most likely follows recurrence. Consequently, it may assist doctors in patient selection and finding the potential best treatment for each individual accordingly. The techniques disclosed herein facilitate atlas construction based on CT scans taken pre-ablation in two cohorts to predict recurrence. A new hierarchical method for atlas construction of a pulmonary vein (PV) is disclosed in which some constraints are applied to the PV branches to preserve fidelity and avoid over registration.

The areas of significant shape difference (SOI regions) on the PV primary branches between the AF+ and AF- patients were identified from pre-ablation CT scans. Those regions could potentially represent future sites of recurrence and hence could be new targets for ablation. Then, a set of texture and shape based features including the fractal, roughness based propriety based and pyradiomics features were extracted from the PV primary and secondary branches and also within or outside of the shape difference regions. Features extracted specifically from the SOI regions on pre-ablation CT scans may be better predictors of the AF recurrence.

The following example describes performance of the hierarchical atlas construction method 200 applied to clinical data to better understand the link between shape remodeling of the left atrium (LA) and pulmonary vein (PV) and the recurrence of atrial fibrillation post ablation. The described method was performed to make two shape variation atlases of the left atrium regions (e.g., left atrium and pulmonary veins) of patients who experienced recurrence and patients who did not experience recurrence. Using the atlases, the regions of the significant shape differences were identified as surface of interest (SOI) regions.

The segmentations of LA and PV were obtained by using a segmentation framework based on nnUNet. The output of the low resolution nnUnet and full resolution nnUnet were combined to obtain the PV segmentation. In order to train the PV segmentation framework, 130 CT images originally annotated by a cardiologist as the trainset were used. To obtain LA segmentation, 130 cases from a first hospital (H1) and 170 cases from a second hospital (H2) were annotated by a cardiologist and a radiologist and were used to train a low resolution nnUNet model. On the PV segmentation, narrow branches were omitted by using morphological operations to obtain the primary branches.

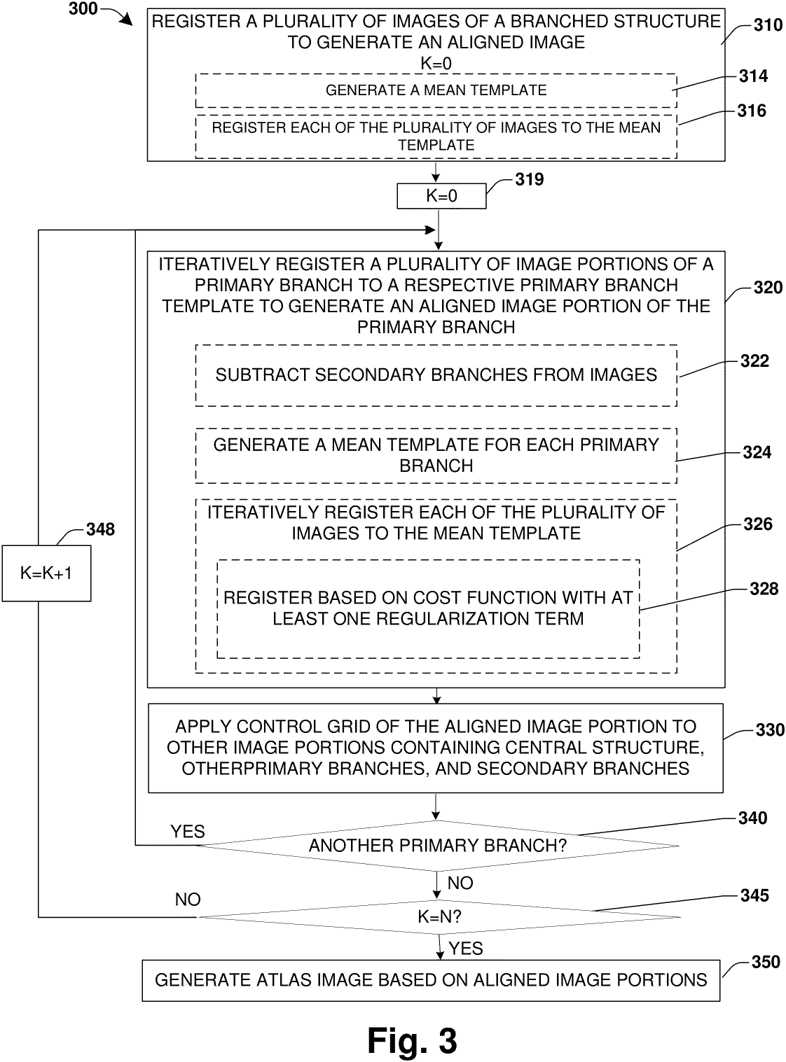

Referring now to FIG. 3, a flow diagram of a method 300 performed on the clinical data described above is illustrated.

310: Branched Structure (e.g., left atrium region) registration.

314: Generate a mean template.

First an arbitrary patient in each cohort was selected as a template. An intensity-based affine registration was used to register all images to their own template. The choice of template affects the atlases in a way that makes bias toward the selected template. To remove this bias, the average of the registered images in each cohort were obtained and the corresponding average in AF+ and AF- cohorts were selected as a new template.

316: Register each of the plurality of images to the mean template.

Using the new template, all images in each cohort were affinely registered to the respective new templates to align all images in each cohort. The image average of this step at the primary branches is the mean template for the operations at 320.

319/320: Iteratively register a plurality of image portions of a primary branch (e.g., pulmonary vein) to a respective primary branch (e.g., pulmonary vein) template to generate an aligned image portion of a primary branch (e.g., pulmonary vein) and repeat iterative registration loop N times.

To align the primary branches (e.g., pulmonary veins), the registration of each branch in the multi process registration was a focus of the method.

322: Subtract secondary branches (e.g., secondary pulmonary veins) from images.

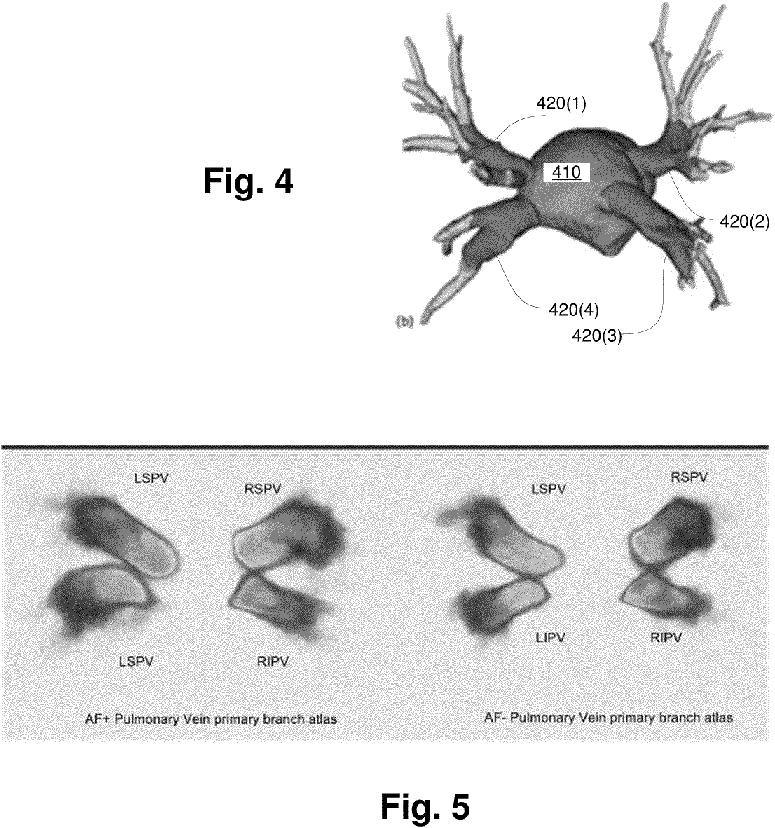

Morphological operations were used to delete the secondary branches (e.g., secondary pulmonary veins)to focus on the registration of the primary branches (e.g., pulmonary veins) first. Primary branches were segmented from the surface junction of the left atrium and pulmonary vein. FIG. 4 shows the left atrium 410 and 4 pulmonary vein primary branch’s segmentations 420(1) - 420(4).

324: Generate mean template for each a primary branch (e.g., pulmonary vein).

For each of the four branches a primary arbitrary template was selected. Take the right superior pulmonary vein (RSPV) as an example, a patient with average (or near average) RSPV volume of all RSPV branches in other patients in the same cohort was selected as the primary RSPV branch template. Then, intensity based affine registration toward the selected template was applied on the segmented RSPV CT images for aligning the RSPV branches to find a mean template. To remove the bias of the template selection, the average images of the registered branches were considered as the mean template for the registered branches. Then an iterative approach was applied for primary branch registration to the mean template.

326: Iteratively register each of the primary branch regions of the plurality of images to the mean template

328: Register based on cost function including at least one L2 regularization term

After getting the mean template for each branch, starting from the RSPV branch, a BSpline non-rigid registration using both log of determinant of Jacobean and L2 norm regularization was used to register RSPV ROI to the mean template. The non-rigid intensity based registration is formulated as an optimization problem in which the objective is to reduce a cost function in which the first term reduces the intensity-based similarity between the moving image and the fixed image and the other terms added to the cost function to control the cost related to specific deformations. For the branch registrations, non-rigid intensity based registration on the CT image was used. Two regularities of L2 norm and log of determinant of Jacobean were added to the cost function. The L2-regularization term was added to suppress the over-registration problem and enable the registration of images with local as well as global distortions. To regulate the unrealistic deformation of branches during registration, the Jacobean of the transformation matrix was included in the cost function. An incompressibility constraint penalty term in the cost function is defined as follows:

$${E}_{J a c o b e a n} = {\int }_{{V}_{R}} \left|\text{log} \left({J}_{T} x\right)\right| d x$$

Where J is the Jacobian determinant and V_{R} is the volume of the reference image.

This term penalizes local large deformations in the form of local deviations of Jacobean from unity deviations of Jacobean from unity.

330: Apply control grid of the aligned image portion to the other image portions containing the central structure (e.g., left atrium), other a primary branches (e.g., pulmonary veins), and secondary branches (e.g., secondary pulmonary veins).

After aligning RSPV with the template of the cohort, the control point grid of this registration was applied to the image portions of the left atrium and the other three branches of right inferior pulmonary vein (RIPV), left superior pulmonary vein (LSPV), and left inferior pulmonary vein (LIPV) in order to preserve the connectivity of the rest of the body with the registered branch (RSPV). After the registration process of the RSPV, the RIPV, LSPV, and LIPV were registered using three additional passes through operations 322–340 via looping condition 350.

345: Repeat registration of a primary branches (e.g., pulmonary veins) N times.

When all the primary branches had been registered to their mean template once, operations 322–340 were repeated in N iterations sequentially in a similar way for finer adjustments of the primary branches with their respective template. In one example, N may be 16. Finishing the registration of the primary branches, the secondary branches were transformed to under the same registration parameters to maintain their connectivity with the primary branches to generate an atlas for the cohort.

350: Generate atlas image (for a cohort) based on the aligned image portions.

The method 300 was performed again on images from patients in the second cohort to generate a second atlas, thus an AF+ atlas and an AF- atlas are generated for future study. FIG. 5 illustrates example atlas images for patients who experienced atrial fibrillation after an ablation treatment (AF+ cohort) and for patients wo did not experience atrial fibrillation after an ablation treatment (AF- cohort).

### Statistically Significant Shape Differences

In order to compare and analyze statistically the shape variations in the two cohorts, AF+ and AF- atlases should be in the same space. Hence, the average branch templates of the AF- group were selected as the main templates. Then the average branch templates in the AF+ cohort were affinely registered to the AF-template. Subsequently, all the cases in AF+ space were transformed to the AF- space by the same registration transformation parameters. Generalized Linear Model (GLM) based t-test model were applied to identify the statistically significant shape difference regions among the primary branches of AF+ and AF- patients. The areas with p-value greater than 0.05 were identified as statistically significant regions.

### Feature Extraction

The designated features measure the roughness and complexity of the targeted segments, e.g. primary and secondary branches.

1) Fractal features: An import aim for fractal measurement is the quantification of the morphological patterns among AF+ and AF- patients. Numerical and statistical self similarity measures can show up when objects are scaled down. The fractal features were measured in both the spatial and frequency domain. Overlapping box counting method was used for measuring 3D and 2D fractal features in spatial domain. There are various methods of implementing box counting method such as conventional, folding, overlapping. Fractal dimension (FD) slope is the slope of the logarithmic regression line of scale and number of overlapped grid boxes with the region of interest (ROI) while FD intercept is the intercept of the logarithmic regression line. If a shape is a fractal the log-log plot shows a straight line. However, in most of the surfaces in nature, the fractal feature is not shown over all scales. The data were extracted over 30 samples of scales in each image while the number of considered samples is different according to the linear line construction for each image. Fast Fourier Transform (FFT) was used for getting the 2D and 3D FD features in the frequency domain.

For getting 2D features, the aforementioned methods were applied over each slice of the binary segmentation of each CT image. The mean of the fractals in all dimensions over a slice is measured. Then the mean, max, variance and standard deviation (std) of the FD over all slices are calculated for each image. 3D features were directly extracted from the 3D image.

The mean, median, max, skewness, variance, and standard deviation of the fractal dimension slope and intercept in spatial and frequency domain were measured as features. These features were calculated in 2D and 3D. This resulted in 48 features extracted from the primary branches and 48 features from the secondary branches.

2) Roughness shape-based Features: Roughness shape-based features measure the roughness of the segments. These features are extracted from the constructed mesh of the targeted segments. The features include mesh roughness from Gaussian Curvature, Difference of Normals (DON), and vertex local spatial density. The mean, variance, standard deviation, and skewness of these features were extracted. There were totally 12 mesh based features. Mesh roughness from Gaussian Curvature represents the deviation of the surface from a planar area. The DON detects surface changes at high frequencies, with focus at the edges. To compute local vertex intensity, a percentage interval of 0.1% to 0.5% of the segment size was chosen and the number of vertices in that vicinity of the corresponding area were measured. A max number threshold is chosen. If the number exceeded the threshold in each percentage, a score was added to the focused vertex. The score was proportionally correlated with the density. Consequently, this example method results in a vertex density score based on the global density of the object at multiple sizes.

### Experimental Results

This section presents results of experiments that were designed to evaluate the performance of the proposed method in finding the surface of interest and evaluate that whether shape remodeling in left atrium and pulmonary vein are associated with the recurrence post ablation.

### Dataset

This study included pre-ablation CT scans of three cohorts of patients diagnosed with atrial fibrillation and underwent catheter ablation. The cohort I, patients received treatment in H1 between 2013-2016. In total from 132 patients 17 patients were excluded due to artifacts and poor contrast which hardened the segmentation. Hence, this dataset includes 56 patients who experience recurrence post ablation and 59 patients who did not experience AF recurrence. The cohort II includes 503 cases from H1 in which 126 cases belong to a same CT series were included. The cohort III which is used as the external validation (for atlas evaluation)/external test set (for feature extraction evaluation) includes 137 cases from H2.

### Results

Atlas construction: The registration error for atlas construction are measured by dice coefficient. Dice coefficient demonstrates the overlap percentage of the moving image with the reference image after registration. To avoid overfitting and also keep the branches fidelity, the maximum dice score has been limited.

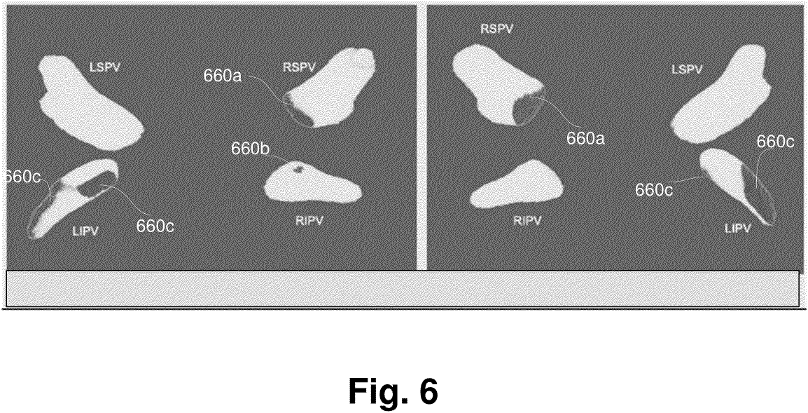

1) Statistically significant shape difference regions: To identify the areas of significant shape difference (p-value<0.05) among AF+ and AF- patients all the images should be in the same space. After constructing the atlases for each cohort, all images resulted from 9 iterations of registration in the AF+ cohort were transferred to the final AF- space using an affine registration. The AF- template was the summation of the individual PV branch templates plus the LA average template. Generalized Linear Model (GLM) based t-test is applied on the signed distance function (SDF) of the registered AF+ and AF- primary branch regions. The resulting SOI regions 660a–660c are shown in FIG. 6, which depicts the AF- atlas image. The view on the left is a front view and the view on the right is a rear view.

Feature Extraction from PV primary branches: To identify morphological and texture variation of the PV primary and secondary branches in patients, 68 radiomic features including 51 shape based features and 17 texture based features were extracted. Shape based features characterize 3D and 2D size and morphology of the regions of interest. Since these features are not correlated with the CT intensity, they were extracted from the binary mask of the ROIs. Texture features were extracted from the 3D CT image and quantify the CT image intensities.

In the category of roughness shape-based features, Difference of Normals represents the high frequency of changes on the surface with the focus on the areas near the edges and holes. Vertex Local Spatial Density represents the areas of high vertex density. Local Roughness from Gaussian Curvature quantifies the geometric surface disturbance on the smooth areas.

The two tests of Mann-Whitney U-Test and non-independent t-test based on normality of the features were used to identify the statistically significant features (p-value < 0.05).

Feature Extraction from PV primary branches: For PV primary branches 19 features (8 roughness features, 11 fractal features, and volume) were identified as statistically significant (pvalue < 0.05). A Naive Bayse classifier was trained on 99 AF+ and 99 AF- cases and has been tested on the 20 AF+ and 90 AF- cases. The model performance was evaluated via area under the curve (AUC) for accuracy, specificity, and sensitivity score.

Feature Extraction from PV secondary branches: The same set of features were extracted from PV secondary branches. Using Mann-Whitney U-Test and non-independent t-test based on the distribution of features (parametric or non-parametric feature sets) several features were found statistically significant.

The combined model of PV primary and secondary branches: Combination of significant features of primary and secondary branches was used to build a classifier model using the same training and test dataset used for primary branches. A Naive Bayes classifier were trained. The results show an improvement in the recurrence prediction when both the primary and secondary branches are considered in the classification. The AUC, accuracy, specificity, and sensitivity, are 0.7, 0.66, 0.65, 0.7 respectively.

Feature extraction from the SOI regions: The same set of features were extracted from the areas of significant shape difference among AF+ and AF- group (SOI regions) mapped on each image of the plurality of images from the template image

The new atlas construction method disclosed herein provides a basis for a new avenue for making atlases of the tubular multi-tree structures to compare shape differences among different cohorts.

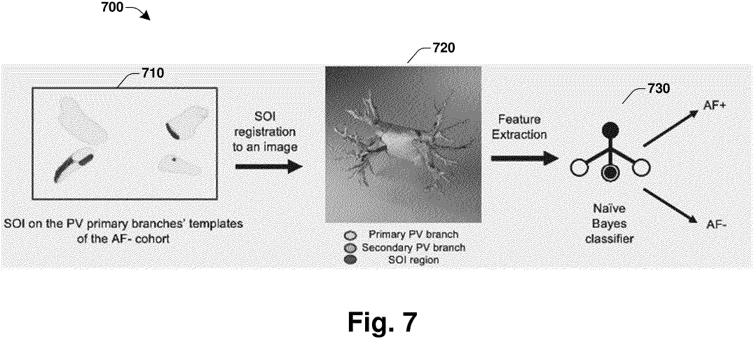

FIG. 7 is an overview diagram of a method 700 for predicting a probability of success of an ablation treatment. The method includes, at 710, identifying a surface of interest on an image of a left atrial region of a heart based on a mapping of corresponding surfaces of interest representing areas of significant shape difference on a final template of atlas image of patients who did not experience a recurrence of atrial fibrillation after an ablation treatment. At 720, features are extracted from SOI regions, primary, and secondary branch pulmonary veins. The method includes, at 730, predicting a probability of success of the ablation treatment based on a classifier result according to the extracted features. Referring back to FIG. 6, in one example, the surface of interest comprises a surface of a right superior pulmonary vein proximate a left atrium (660a), a small region near the left atrium on the right inferior pulmonary vein (660b), and a large region on the left inferior pulmonary vein (660c).

While the disclosed methods are illustrated and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

Examples herein can include subject matter such as an apparatus, including an ablation recurrence prediction apparatus or system, a digital whole slide scanner, a CT system, an MRI system, a personalized medicine system, a CADx system, a processor, a system, circuitry, a method, means for performing acts, steps, or blocks of the method, at least one non-transitory computer-readable medium including executable instructions that, when performed by a machine (e.g., a processor with memory, an application-specific integrated circuit (ASIC), a field programmable gate array (FPGA), or the like) cause the machine to perform acts of the method or of an apparatus or system for predicting ablation recurrence, according to embodiments and examples described.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Non-transitory computer-readable storage device” or “Non-transitory computer-readable medium”, as used herein, refers to a device that stores instructions or data. or “Non-transitory computer-readable medium” do not refer to propagated signals. A computer-readable storage device or computer-readable medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage device may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

“Circuit”, as used herein, includes but is not limited to hardware, firmware, software in execution on a machine, or combinations of each to perform a function(s) or an action(s), or to cause a function or action from another logic, method, or system. A circuit may include a software controlled microprocessor, a discrete logic (e.g., ASIC), an analog circuit, a digital circuit, a programmed logic device, a memory device containing instructions, and other physical devices. A circuit may include one or more gates, combinations of gates, or other circuit components. Where multiple logical circuits are described, it may be possible to incorporate the multiple logical circuits into one physical circuit. Similarly, where a single logical circuit is described, it may be possible to distribute that single logical circuit between multiple physical circuits.

To the extent that the term “includes” or “including” is employed in the detailed description or the claims, it is intended to be inclusive in a manner similar to the term “comprising” as that term is interpreted when employed as a transitional word in a claim.

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and other embodiments were illustrated by describing examples, and while the examples were described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

What is claimed is:

1. A non-transitory computer-readable medium storing computer-executable instructions that, when executed, cause a processor to perform operations, corresponding to:
registering a plurality of images of instances of a branched structure to generate an aligned image for a cohort, wherein the branched structure comprises a central structure and at least one primary branch connected to the central structure;
for each primary branch of the branched structure,
iteratively registering respective portions of a plurality of images containing the primary branch to generate an aligned image portion of the primary branch; and
applying a control grid of the aligned image portion of the primary branch to respective image portions containing the central structure and the other primary branches prior to iteratively registering a next primary branch; and
generating an atlas image for the cohort based on the aligned image portions.

2. The non-transitory computer-readable medium of claim 1, wherein the instructions further comprise instructions that, when executed, cause the processor to perform operations corresponding to, for each secondary branch connected to a primary branch of the branched structure, applying registration parameters associated with the primary branch to generate an aligned image portion of the secondary branch.

3. The non-transitory computer-readable medium of claim 1, wherein the instructions further comprise instructions that, when executed, cause the processor to perform operations corresponding to iteratively registering a primary branch by
choosing an arbitrary image portion of the plurality of images as a template;
performing an affine registration of an image portion of each remaining image of the plurality images to the template to generate a mean template; and
iteratively registering each of the plurality of images or image portions to the mean template to generate the aligned image portion of the primary branch.

4. The non-transitory computer-readable medium of claim 1, wherein the instructions further comprise instructions that, when executed, cause the processor to perform operations corresponding to subtracting, removing secondary branches from each of the plurality of images prior to generating aligned images of the primary branches.

5. The non-transitory computer-readable medium of claim 1, wherein the instructions further comprise instructions that, when executed, cause the processor to perform operations corresponding to iteratively registering the respective portions of the plurality of images containing the primary branch using a non-rigid intensity based registration based on a cost function that includes at least one regularization term.

6. The non-transitory computer-readable medium of claim 5, wherein the at least one regularization term includes a log of a determinant of a Jacobean and at least one L2 regularization term.

7. The non-transitory computer-readable medium of claim 1, wherein the instructions further comprise instructions that, when executed, cause the processor to perform operations corresponding to
registering an atlas image of a first cohort to an atlas image of a second cohort to align all images in both cohorts to a same spatial basis; and
analyzing the aligned images to identify regions of interest within one or more primary branches having a statistically different shape as between the first cohort and the second cohort.

8. The non-transitory computer-readable medium of claim 7, wherein the instructions further comprise instructions that, when executed, cause the processor to perform operations corresponding to
extracting shape and texture-based fractal features in the regions of interest; and
extracting mesh-based features in the regions of interest.

9. The non-transitory computer-readable medium of claim 8, wherein the instructions further comprise instructions that, when executed, cause the processor to perform operations corresponding to classifying a subsequent image as belonging to the first cohort or the second cohort based on a comparison of extracted features of the subsequent image with the extracted features from the images of the first cohort and the images of the second cohort.

10. The non-transitory computer-readable medium of claim 1, wherein the central structure comprises a left atrium and the primary branches comprise a right superior pulmonary vein (RSPV), a right inferior pulmonary vein (RIPV), a left superior pulmonary vein (LSPV), and a right inferior pulmonary vein (LIPV).

11. The non-transitory computer-readable medium of claim 10, wherein a first cohort comprises patients who experienced a post-ablation recurrence of atrial fibrillation and a second cohort comprises patients who did not experience a post-ablation recurrence of atrial fibrillation.

12. The non-transitory computer-readable medium of claim 10, wherein the plurality of images comprise CT scans of the left atrium and pulmonary veins connected to the left atrium taken prior to an ablation treatment.

13. The non-transitory computer-readable medium of claim 1, wherein the central structure comprises a central airway branch and the primary branches comprise airway branches that branch from the central airway branch.

14. The non-transitory computer-readable medium of claim 1, wherein the central structure comprises a tumor and the primary branches comprise a vascular network associated with the tumor.

15. The non-transitory computer-readable medium of claim 1, wherein the branched structure comprises a vascular network of an eye.

16. A method for generating an atlas of a left atrial region of a heart, comprising:
registering a plurality of images of instances of left atrial region taken prior to an ablation treatment to generate an aligned image for a cohort, wherein the left atrial region comprises a left atrium and at least one pulmonary vein connected to the left atrium;
for each pulmonary vein of the left atrial region,
iteratively registering respective portions of a plurality of images containing the pulmonary vein to generate an aligned image portion of the pulmonary vein; and
applying a control grid of the aligned image portion of the pulmonary vein to respective image portions containing the left atrium and the other pulmonary veins prior to iteratively registering a next pulmonary vein; and
generating an atlas image for the cohort based on the aligned image portions.

17. The method of claim 16, further comprising for each secondary pulmonary vein connected to a pulmonary vein of the left atrial region, applying registration parameters associated with the pulmonary vein to generate an aligned image portion of the secondary pulmonary vein.

18. The method of claim 16, further comprising iteratively registering a pulmonary vein by
choosing an arbitrary image portion of the plurality of images as a template;
performing an affine registration of an image portion of each remaining image of the plurality images to the template to generate a mean template; and
iteratively registering each of the plurality of images or image portions to the mean template to generate the aligned image portion of the pulmonary vein.

19. The method of claim 16, further comprising subtracting, removing secondary branches from each of the plurality of images prior to generating aligned images of the primary branches.

20. The method of claim 16, further comprising:
registering an atlas image of a first cohort to an atlas image of a second cohort to align all images in both cohorts to a same space; and
analyzing the aligned images to identify regions of interest within one or more primary branches having a statistically significant different shape as between the first cohort and the second cohort.

21. The method of claim 20, further comprising classifying a subsequent image as belonging to the first cohort or the second cohort based on a comparison of extracted features of the subsequent image with the extracted features from the aligned images of the first cohort and the aligned images of the second cohort.

22. A method for predicting a probability of success of an ablation treatment, comprising:
obtaining one or more surfaces of interest on an image of a left atrial region of a heart based on a mapping of corresponding surfaces of interest representing areas of significant shape difference on a final template of an atlas image of patients who did not experience a recurrence of atrial fibrillation after an ablation treatment;
extracting features from the surfaces of interest, primary pulmonary veins, and secondary pulmonary veins; and
predicting the probability of success of the ablation treatment based on classifier results according to the extracted features.

23. The method of claim 22, wherein the one or more surfaces of interest comprise a surface of a right superior pulmonary vein proximate a left atrium, a small region near LA on the right inferior pulmonary vein, or a large region on the left inferior pulmonary vein..
